(19) United States
(12) Patent Application Publication
(10) Pub. No.: US 2025/0282306 A1
(43) Pub. Date: Sep. 11, 2025

(54) DECORATIVE GLASS PANEL FOR VEHICLE'S INTERIOR

(71) Applicant: AGC GLASS EUROPE, Louvain-la-Neuve (BE)

(72) Inventors: Xavier CARNOY, Thimister-Clermont (BE); Robert HICK, Chênée (BE); Thomas LAMBRICHT, Perwez (BE); Laurent VANDIEVOET, Fleurus (BE)

(73) Assignee: AGC GLASS EUROPE, Louvain-la-Neuve (BE)

(21) Appl. No.: 18/858,997

(22) PCT Filed: Apr. 25, 2023
(86) PCT No.: PCT/EP2023/060735

§ 371 Date: Oct. 22, 2024

(30) Foreign Application Priority Data
May 4, 2022 (EP) 22171542.8

(51) Int. Cl. B60R 13/02; B29C 45/14; B29L 11/00; B29L 31/30; B60Q 3/54

(52) U.S. Cl. CPC B60R 13/02; B29C 45/14434; B29C 45/14467; B60Q 3/54; B29C 2045/14532; B29L 2011/0075; B29L 2031/3005; B60R 2013/0287

(57) ABSTRACT

A decorative panel for a vehicle's interior, the panel including a carrier adapted to fix the decorative panel on the vehicle. The decorative panel further includes a glass sheet with an internal face and an external face. The decorative panel also includes an adhesion layer. The adhesion layer is positioned between the carrier and the internal face of the glass sheet. The adhesion layer integrally covers the internal face of the glass sheet. The luminous transmittance of the adhesion layer is at least 1%. The combination of the decorative panel with a light source is also considered.

### FIELD OF THE INVENTION

The present invention relates to a decorative glass panel. More specifically it relates to a decorative glass panel particularly advantageous for automotive applications as a vehicle's interior glazing, allowing backlighting or lighting through the edges, while replying to safety constraints.

### BACKGROUND OF THE INVENTION

There is a need in the automotive market for decorative glass panels, especially in luxury car segment. Decorative plastic panels are considered as low quality, especially from an aesthetical point of view. Besides, plastic is much more sensitive to impacts and scratches compared to glass. Moreover plastic usually ages by yellowing, while glass keeps its optical quality throughout the years.

Besides the decorative glass panel must reply to two antagonist requests: it has to be resistant and lightweight. The resistance requirement tends to orient towards thick glass sheet. However, such thick glass sheet is usually quite heavy and adds to the total weight of the vehicle. One tends therefore to opt for thin glass sheet, but then faces the security requirements. Indeed if a decorative glass panel is installed inside of a car, and in case of breakage, passenger security must be ensured towards glass fragments. The use of a security film, usually being a plastic layer positioned next to the glass panel in order to hold the pieces of glass in case of breakage, leads to the use of an additional element, rendering the integration into the vehicle more complex, and therefore further increasing the cost of the decorative panel. Another option is therefore to use tempered glass, which has been strengthened either through thermal or chemical tempering.

The automotive industry is seeking for decorative glass panels further allowing illumination. Decorative glass panels are usually made of a glass sheet adhered to a carrier. WO2020178383A1 describes a method to manufacture a decorative panel by injecting a soft material between a glass sheet and a carrier. This document shows an example of edge lighting. However, such integration through the edges of the glass sheet often leads to light contamination on the whole decorative glass panel, while car manufacturers ask for a sharp and seamless design, with light present only in parts of the decorative glass panel.

There is therefore a need for a decorative glass panel allowing more flexibility in term of lighting integration, while ensuring compliance with security requirements as well as with industrial processes.

### SUMMARY OF THE INVENTION

The present invention concerns a decorative panel for a vehicle's interior. Such decorative panel comprises a carrier adapted to fix the decorative panel on the vehicle. The decorative panel further comprises a glass sheet with an internal and an external faces. The decorative panel further comprises an adhesion layer. The adhesion layer is positioned between the carrier and the internal face of the glass sheet. The adhesion layer integrally covers the internal face of the glass sheet. The luminous transmittance of the adhesion layer is at least 1%, preferably at least 5%, more preferably at least 10%, even more preferably at least 50%.

The present invention also concerns the use of such decorative panel in combination with a light source.

The present invention further concerns a method to manufacture such decorative panel.

### BRIEF DESCRIPTION OF THE DRAWINGS

The invention will now be described further, by way of examples, with reference to the accompanying drawings, wherein like reference numerals refer to like elements in the various figures. These examples are provided by way of illustration and not of limitation. The drawings are a schematic representation and not true to scale. The drawings do not restrict the invention in any way. More advantages will be explained with examples.

FIG. 1a illustrates a decorative panel according to one embodiment of the invention. FIG. 1b illustrates the same decorative panel with an additional primer.

FIG. 2a illustrates a decorative panel according to another embodiment of the invention. FIG. 2b illustrates the same decorative panel with an additional primer.

FIG. 3 illustrates a decorative panel according to another embodiment of the invention.

FIG. 4 illustrates a decorative panel according to another embodiment of the invention.

### DETAILED DESCRIPTION OF ILLUSTRATIVE EMBODIMENTS

The present invention will be described with respect to particular embodiments and with reference to certain drawings but the invention is not limited thereto but only by the claims.

While some embodiments described herein include some but not other features included in other embodiments, combinations of features of different embodiments are meant to be within the scope of the invention, and form different embodiments, as would be understood by those in the art. For example, in the following claims, any of the claimed embodiments can be used in any combination.

The present invention proposes a decorative panel for a vehicle's interior. A decorative panel according to the invention is mounted on any part in the vehicle's interior in order to provide a better aesthetic or to secure or protect some part of the vehicle's interior. Such decorative panel can be mounted to cover (either fully or partially) doors, door handles contours, parts of the dashboard or the center console (where the center console means the console between the front passengers' seats, which can extend towards the dashboard), back of seats (including headrest's back), roofs, armrests, . . . . A vehicle refers to any kind of vehicles such as (but not restricted to) a car, a van, a lorry, a motorbike, a bus, a tram, a train, a drone, an airplane, an helicopter and the like.

The decorative panel comprises a carrier adapted to fix the trim element on the vehicle's interior. Such carrier is usually made of a material chosen among thermoplastics such as for example polybutylene terephthalate (PBT), polycarbonate-acrylonitrile butadiene styrene (PC-ABS), polyamide (PA6), polyamide copolymer (PA66), polyoxymethylene (POM), polypropylene (PP), thermoplastic elastomers (TPE) or thermosets material such as polyurethane (PUR), epoxies (EP) with or without fillers to bring additional properties, such as glass fibers for mechanical reinforcement. The carrier could also be made of metallic material such as zamac, aluminum, magnesium (thixomolding). The carrier plate may be made of a fiber reinforced plastic, talc reinforced plastic or glass beads reinforced plastic. The carrier could also be made of glass, ceramic, stone, marble, wood or any other material suitable to produce a carrier.

The decorative panel further comprises a glass sheet with an external face and an internal face. The internal face refers to the face facing the carrier, while the external face refers to the opposite face. The glass sheet has a composition that is not particularly limited. The glass sheet may be a soda-lime-silicate glass, an alumino-silicate glass, an alkali-free glass, a boro-silicate glass, etc. Preferably, the glass sheet of the invention is made of a soda-lime glass or an alumino-silicate glass. The glass sheet according to the invention may be a glass sheet obtained by a floating process, a drawing process, a rolling process or any other process known to manufacture a glass sheet starting from a molten glass composition. According to a preferred embodiment according to the invention, the glass sheet is a float glass sheet. The term “float glass sheet” is understood to mean a glass sheet formed by the float glass process, which consists in pouring the molten glass onto a bath of molten tin, under reducing conditions. The glass sheet preferably has a thickness comprised between 0.5 and 2.1 mm.

According to an embodiment of the invention, the glass sheet has a composition comprising, in a content expressed in percentages of the total weight of the glass:

| | |
|---|---|
| SiO₂ | 55-85% |
| Al₂O₃ | 0-30% |
| B₂O₃ | 0-20% |
| Na₂O | 0-25% |
| CaO | 0-20% |
| MgO | 0-15% |
| K₂O | 0-20% |
| BaO | 0-20%. |

In a preferred embodiment, the glass sheet has a composition comprising, in a content expressed in percentages of the total weight of the glass:

| | |
|---|---|
| SiO₂ | 55-70% |
| Al₂O₃ | 0-25% |
| B₂O₃ | 0-10% |
| Na₂O | 5-20% |
| CaO | 0-5% |
| MgO | 0-15% |
| K₂O | 0-10% |
| BaO | 0-5%. |

In a more preferred embodiment, the glass sheet has a composition comprising, in a content expressed in percentages of the total weight of the glass:

| | |
|---|---|
| SiO₂ | 60-70% |
| Al₂O₃ | 5-20% |
| B₂O₃ | 0-5% |
| CaO | 0-3% |
| MgO | 0-10% |
| Na₂O | 10-20% |
| K₂O | 0-5% |
| BaO | 0-5%. |

In a more preferred embodiment, the glass sheet has a composition comprising, in a content expressed in percentages of the total weight of the glass:

| | |
|---|---|
| SiO₂ | 65-70% |
| Al₂O₃ | 4-8% |
| B₂O₃ | 0-1% |
| CaO | 0-2% |
| MgO | 7-12% |
| Na₂O | 14-18% |
| K₂O | 0-2% |
| BaO | 0-1%. |

Such composition is a good compromise between the mechanical performances of the glass after chemical strengthening and cost optimization.

In a more preferred embodiment, the glass sheet has a composition comprising, in a content expressed in percentages of the total weight of the glass:

| | |
|---|---|
| SiO₂ | 65-75% |
| Al₂O₃ | 0-3% |
| B₂O₃ | 0-1% |
| CaO | 5-10% |
| MgO | 4-8% |
| Na₂O | 10-15% |
| K₂O | 0-1% |
| BaO | 0-1%. |

The decorative panel further comprises an adhesion layer. The adhesion layer is positioned between the carrier and the internal face of the glass sheet. The adhesion layer integrally covers the internal face of the glass sheet. The adhesion layer integrally covering the internal face of the glass sheet allows to increase the safety towards occupant of the vehicle in case of break of the glass sheet. Indeed, it allows to avoid projection of glass sheet pieces in case of break of the glass sheet as they adhere to the carrier thanks to the adhesion layer.

The adhesion layer is required to be transparent or translucent to visible light. Visible light means light corresponding to the visible wavelength range, meaning comprised within 380 nm and 780 nm. In the present description, to quantify the luminous transmittance, one considers the total light transmission with illuminant D65 (LTD) at a solid angle of observation of 2° (according to standard ISO9050). The luminous transmittance represents the percentage of light flux emitted between wavelengths 380 nm and 780 nm which is transmitted through the adhesion layer. By transparent or translucent, the adhesion layer is understood to have a luminous transmittance of at least 1%. The luminous transmittance of the adhesion layer can be at least 3%, 5%, 10%, 20%, 30%, 40%, 50%, 60%, 70%, 80%, 90%, 95%, 99%.

In a preferred embodiment, the internal face of the glass sheet is at least partially covered with an opaque layer whose luminous transmittance is below 1%. To quantify the luminous transmittance, one considers the total light transmission with illuminant D65 (LTD) at a solid angle of observation of 2° (according to standard ISO9050). The luminous transmittance represents the percentage of light flux emitted between wavelengths 380 nm and 780 nm which is transmitted through the opaque layer. Such opaque layer can be an ink layer, a lacquer, an enamel, a paint, a layer deposited by plasma vapor deposition. Such opaque layer may be deposited on the glass sheet by any manner known in the art. Non-limiting examples of deposition process for the decoration are silkscreen printing, inkjet printing, laser printing or screen-printing methods. Preferred method is silkscreen printing mainly thanks to its capability to produce high quality coloured patterns, its flexibility and its high deposition speed. Inkjet printing is also a preferred method, as it allows a large flexibility in terms of design. Combination of silkscreen printing and inkjet printing can also be used, to benefit from the advantages of both techniques. Other method for deposition includes spraying technique or curtain coater technique. Alternatively, the opaque layer may also be a film of polymers, which may then deposited by a classical lamination process.

In a preferred embodiment, the carrier comprises at least one hole adapted to let visible light pass through the carrier. Further, the opaque layer on the internal face of the glass sheet is not applied at least where the internal face of the glass sheet matches with the at least one hole in the carrier. The area of the glass sheet matching with the at least one hole in the carrier can also be covered with a transparent or translucent layer. By transparent or translucent, the layer is understood to have a luminous transmittance of at least 1%. The luminous transmittance of the layer can be at least 3%, 5%, 10%, 20%, 30%, 40%, 50%, 60%, 70%, 80%, 90%, 95%, 99%. This transparent or translucent layer can be an ink layer, a lacquer, an enamel, a paint, a layer deposited by plasma vapor deposition. Such transparent or translucent layer may be deposited on the glass sheet by any manner known in the art. Non-limiting examples of deposition process for the decoration are silkscreen printing, inkjet printing, laser printing or screen-printing methods. Preferred method is silkscreen printing mainly thanks to its capability to produce high quality coloured patterns, its flexibility and its high deposition speed. Other method for deposition includes spraying technique or curtain coater technique. Alternatively, the transparent or translucent layer may also be a film of polymers, which may then deposited by a classical lamination process.

In a preferred embodiment, the internal face of the glass sheet is at least partially covered with a translucent or transparent layer whose luminous transmittance is at least 1%. The luminous transmittance of the layer can be at least 3%, 5%, 10%, 20%, 30%, 40%, 50%, 60%, 70%, 80%, 90%, 95%, 99%. To quantify the luminous transmittance, one considers the total light transmission with illuminant D65 (LTD) at a solid angle of observation of 2° (according to standard ISO9050). The luminous transmittance represents the percentage of light flux emitted between wavelengths 380 nm and 780 nm which is transmitted through the translucent or transparent layer. Such translucent or transparent layer can be an ink layer, a lacquer, an enamel, a paint, a layer deposited by plasma vapor deposition. Such translucent or transparent layer may be deposited on the glass sheet by any manner known in the art. Non-limiting examples of deposition process for the decoration are silkscreen printing, inkjet printing, laser printing or screen-printing methods. Preferred method is silkscreen printing mainly thanks to its capability to produce high quality coloured patterns, its flexibility and its high deposition speed. Inkjet printing is also a preferred method, as it allows a large flexibility in terms of design. Combination of silkscreen printing and inkjet printing can also be used, to benefit from the advantages of both techniques. Other method for deposition includes spraying technique or curtain coater technique. Alternatively, the translucent or transparent layer may also be a film of polymers, which may then deposited by a classical lamination process.

In a preferred embodiment, the adhesion layer is adapted to be injected between the carrier and the internal face of the glass sheet. The adhesion layer can be made of a thermoplastic polymer such as polypropylene, thermoplastic elastomers (TPE) such as olefinic thermoplastic elastomers (TPO), polyurethane, polyamide or soft polyvinyl chloride, silicone or similar materials or any material suitable for injection molding.

As an alternative, the adhesion layer can be adhered to the glass by ultrasonic welding. Such technique is less expensive than injection molding.

In a preferred embodiment, the adhesion layer obtained by injection molding is further applied to at least one edge of the glass sheet. It means that the adhesion layer is not only injected to cover the internal face of the glass sheet, but the adhesion layer also covers at least one edge of the glass sheet. Such configuration allows to let light pass in the area surrounding the glass sheet without contaminating the glass with light leakage (light system decoupled from glass). It also allows to cover the entire glass surface with a unique (opaque) decorative layer. There is therefore no need to add a semi-transparent layer to hide the light source behind the glass, leading to lower cost and 100% homogeneity as well as easier processing without printing positioning constraint. Moreover such configuration also allows for easier integration, the adhesion layer playing the role of a soft seal for a possible contact with a rigid surrounding part. This will favorably prevent noise creation for example in case of vibration.

In a preferred embodiment, the glass sheet is chemically tempered. Using chemically tempered glass allows to cold bend the glass, and therefore to put the glass sheet in the desired form. Chemical tempering also improves the mechanical resistance of the glass sheet.

In a preferred embodiment, the internal face of the glass sheet further comprises a primer. The primer is therefore applied on the internal face of the glass sheet previously at least partially covered with the decoration. The use of such primer allows for better adherence with the adhesion layer. Such primer can for example be a primer containing silane. Such primer can instead or also be applied on the carrier, therefore positioned between the carrier and the adhesion layer to increase adhesion of the adhesion layer to the carrier.

In a preferred embodiment, the external face of the glass sheet is also decorated with a paint, through etching or with a layer deposited by plasma vapor deposition.

The present invention also proposes the use of a decorative panel as described previously in combination with a light source, the decorative panel being fixed in the interior of a vehicle.

The present invention also proposes a method to manufacture a decorative panel for a vehicle's interior comprising the following steps:
a) Furnishing a glass sheet having an internal face and an external face;
b) Furnishing a carrier adapted to fix the decorative panel in the vehicle;
c) Injecting an adhesion layer between the internal face of the glass sheet and the carrier, fully covering the internal face of the glass sheet, the luminous transmittance of the adhesion layer being at least 1%, preferably at least 5%, more preferably at least 10%, even more preferably at least 50%.

The luminous transmittance of the layer can be at least 3%, 5%, 10%, 20%, 30%, 40%, 50%, 60%, 70%, 80%, 90%, 95%, 99%.

The injection of the adhesion layer can be done for example through at least one hole in the carrier. It can also be done by the side, between the glass sheet and the carrier.

In a preferred embodiment, the method comprises a step a′. after the step a., the step a′. consisting of covering at least partially the internal face of the glass sheet with a layer whose luminous transmittance is below 1%.

In an alternative embodiment, the method comprises a step a′. after the step a., the step a′. consisting of covering at least partially the internal face of the glass sheet with a layer whose luminous transmittance is at least 1%. The luminous transmittance of the layer can be at least 3%, 5%, 10%, 20%, 30%, 40%, 50%, 60%, 70%, 80%, 90%, 95%, 99%.

In a preferred embodiment, the method further comprises a step of chemical tempering of the glass sheet before step a. and potentially step a′., and a step b′. of cold bending the chemically tempered glass sheet in the carrier after step b.

In a preferred embodiment, the method comprises a step of covering the internal face of the glass sheet with a primer before step b.

In a preferred embodiment, the adhesion layer is further applied to the edges of the glass sheet.

In a preferred embodiment, the carrier is also injected. The method is realized as a 2k-injection process, wherein the carrier is firstly injected and the adhesion layer is secondly injected. The carrier can additionally be made of several sub-components. Such configuration allows for better flexibility for assembly. It also better replies to the constraints due to thermal expansion.

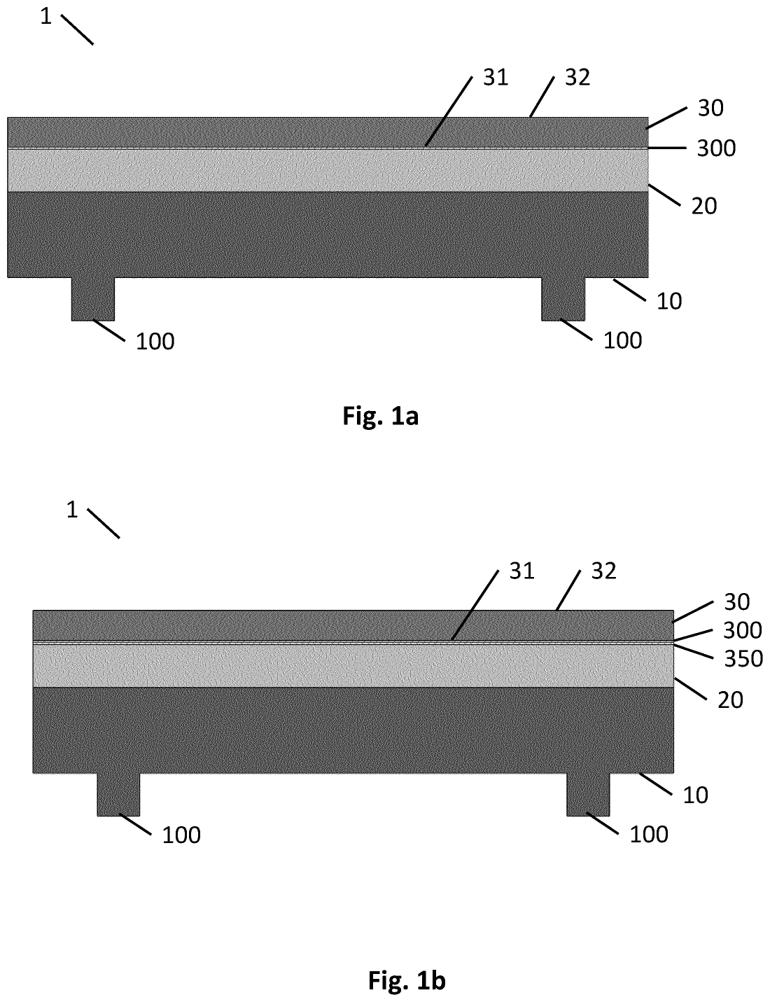

Referring to FIG. 1a, a decorative panel (1) comprises a carrier (10). The carrier is used to fix the decorative panel on the interior of a vehicle (not shown). Here the carrier is represented with two protrusions (100) in order to fix the decorative panel (1). Other means to fix such decorative panel are known by the skilled in the art.

The decorative panel (1) further comprises a glass sheet (30). The internal face (31) of the glass sheet (30) faces the carrier (10), while the external face (32) of the glass sheet (30) faces the interior of the vehicle (not shown) wherein the decorative panel (1) is fixed.

The internal face (31) of the glass sheet (30) is further at least partially covered with a layer (300) whose luminous transmittance is either below 1% or at least 1%. The luminous transmittance of the layer can be at least 3%, 5%, 10%, 20%, 30%, 40%, 50%, 60%, 70%, 80%, 90%, 95%, 99%.

The glass sheet (30) is adhered to the carrier (10) through an adhesion layer (20). The adhesion layer (20) fully covers the internal face (31) of the glass sheet (30).

FIG. 1b shows a similar embodiment of FIG. 1a, except that an additional primer (350) is deposited on the internal face (31) of the glass sheet (30) in order to increase the adhesion of the adhesion layer (20).

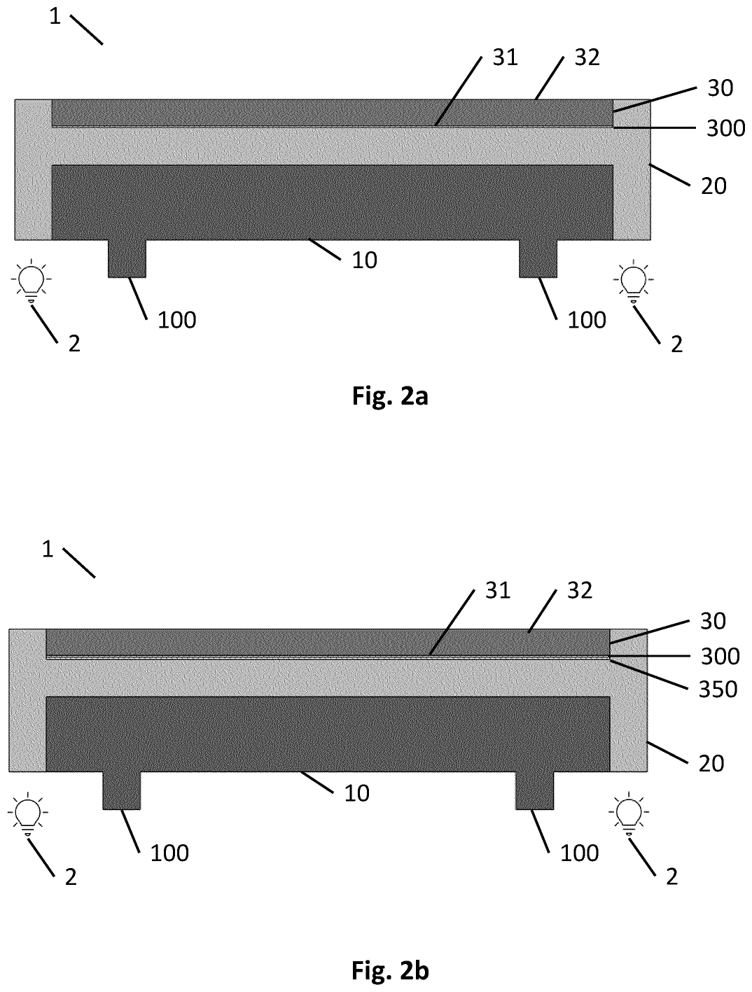

Referring to FIG. 2a, a decorative panel (1) comprises a carrier (10). The carrier is used to fix the decorative panel on the interior of a vehicle (not shown). Here the carrier is represented with two protrusions (100) in order to fix the decorative panel (1). Other means to fix such decorative panel are known by the skilled in the art.

The decorative panel (1) further comprises a glass sheet (30). The internal face (31) of the glass sheet (30) faces the carrier (10), while the external face (32) of the glass sheet (30) faces the interior of the vehicle (not shown) wherein the decorative panel (1) is fixed.

The internal face (31) of the glass sheet (30) is further at least partially covered with an opaque layer (300) whose luminous transmittance is below 1%.

The glass sheet (30) is adhered to the carrier (10) through an adhesion layer (20). The adhesion layer (20) fully covers the internal face (31) of the glass sheet (30). In this example, the adhesion layer (20) also further covers the edges of the glass sheet (30). Such configuration is interesting in case the decorative panel (1) is combined with at least one light source (2). It therefore allows light from the light source (2) to pass through the adhesion layer (20). The opaque layer (300) allows to avoid light contamination from the light source (2) to the glass sheet (30).

FIG. 2b shows a similar embodiment of FIG. 2a, except that an additional primer (350) is deposited on the internal face (31) of the glass sheet (30) in order to increase the adhesion of the adhesion layer (20).

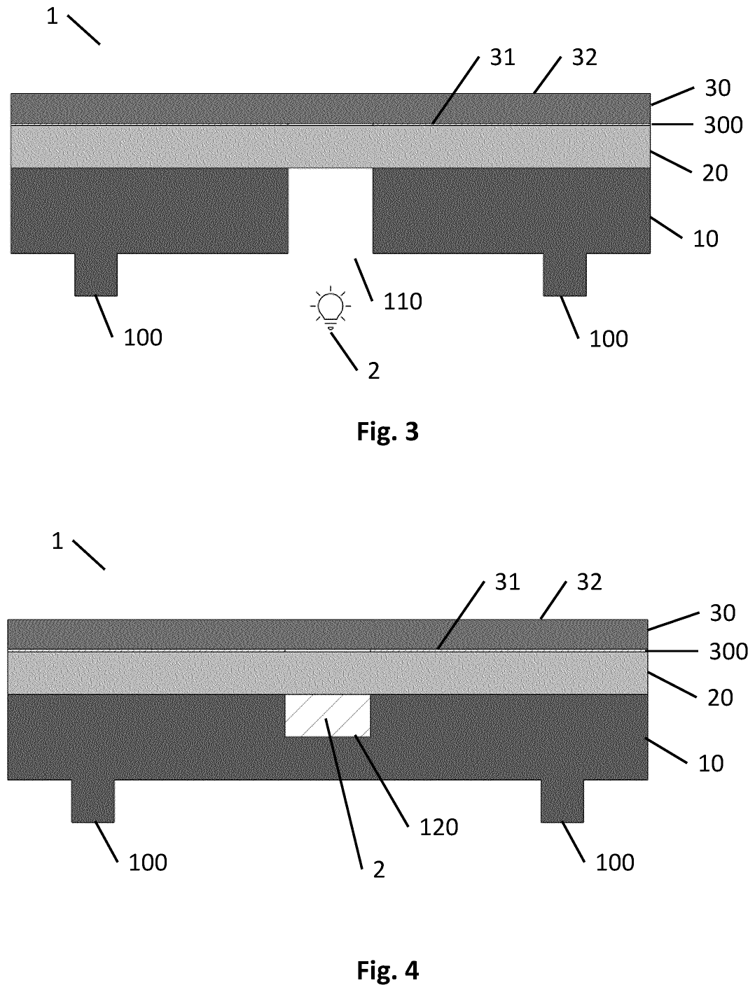

Referring to FIG. 3, a decorative panel (1) comprises a carrier (10). The carrier is used to fix the decorative panel on the interior of a vehicle (not shown). The carrier can also be used to maintain the cold bent glass in its final deformed shape. Here the carrier is represented with two protrusions (100) in order to fix the decorative panel (1). Other means to fix such decorative panel are known by the skilled in the art.

The decorative panel (1) further comprises a glass sheet (30). The internal face (31) of the glass sheet (30) faces the carrier (10), while the external face (32) of the glass sheet (30) faces the interior of the vehicle (not shown) wherein the decorative panel (1) is fixed.

The internal face (31) of the glass sheet (30) is further at least partially covered with an opaque layer (300) whose luminous transmittance is below 1%.

The glass sheet (30) is adhered to the carrier (10) through an adhesion layer (20). The adhesion layer (20) fully covers the internal face (31) of the glass sheet (30).

In this example, the carrier (10) further comprises a hole (110). Such configuration is interesting in case the decorative panel (1) is combined with at least one light source (2). It therefore allows light from the light source (2) to pass through the carrier (10). In this case, the internal face (31) of the glass sheet (30) matching with the hole (110) in the carrier (10) is either not covered by the opaque layer (300) or covered with a transparent or translucent layer (310). The luminous transmittance of the transparent or translucent layer can be at least 1%, 3%, 5%, 10%, 20%, 30%, 40%, 50%, 60%, 70%, 80%, 90%, 95%, 99%.

The opaque layer (300), placed where the internal face (31) of the glass sheet (30) does not match the hole (110) in the carrier (10) allows to avoid light contamination from the light source (2) to the glass sheet (30).

Referring to FIG. 4, a decorative panel (1) comprises a carrier (10). The carrier is used to fix the decorative panel on the interior of a vehicle (not shown). Here the carrier is represented with two protrusions (100) in order to fix the decorative panel (1). Other means to fix such decorative panel are known by the skilled in the art.

The decorative panel (1) further comprises a glass sheet (30). The internal face (31) of the glass sheet (30) faces the carrier (10), while the external face (32) of the glass sheet (30) faces the interior of the vehicle (not shown) wherein the decorative panel (1) is fixed.

The internal face (31) of the glass sheet (30) is further at least partially covered with an opaque layer (300) whose luminous transmittance is below 1%.

The glass sheet (30) is adhered to the carrier (10) through an adhesion layer (20). The adhesion layer (20) fully covers the internal face (31) of the glass sheet (30).

In this example, the carrier (10) further comprises a recess (120). Such configuration is interesting in case the decorative panel (1) is combined with at least one light source (2) which is integrated into the carrier (10). In this case, the internal face (31) of the glass sheet (30) matching with the recess (120) in the carrier (10) is either not covered by the opaque layer (300) or covered with a transparent or translucent layer (310). The luminous transmittance of the transparent or translucent layer can be at least 1%, 3%, 5%, 10%, 20%, 30%, 40%, 50%, 60%, 70%, 80%, 90%, 95%, 99%.

The opaque layer (300), placed where the internal face (31) of the glass sheet (30) does not match the recess (120) in the carrier (10) allows to avoid light contamination from the light source (2) to the glass sheet (30).

While the invention has been illustrated and described in detail in the drawings and foregoing description, such illustration and description are to be considered illustrative or exemplary and not restrictive. The foregoing description details certain embodiments of the invention. It will be appreciated, however, that no matter how detailed the foregoing appears in text, the invention may be practiced in many ways. The invention is not limited to the disclosed embodiments.

1: A decorative panel for a vehicle's interior comprising:
a. a carrier adapted to fix the decorative panel on the vehicle;
b. a glass sheet comprising an internal face and an external face;
c. an adhesion layer positioned between the carrier and the internal face of the glass sheet, the adhesion layer integrally covering the internal face of the glass sheet,
wherein a luminous transmittance of the adhesion layer is at least 1.

2: The decorative panel for a vehicle's interior according to claim 1, wherein the internal face of the glass sheet is at least partially covered with a layer whose luminous transmittance is below 1%.

3: The decorative panel according to claim 2, wherein the carrier comprises at least one hole adapted to let visible light pass through the carrier and wherein the layer on the internal face of the glass sheet is not applied at least where the internal face of the glass sheet matches with the at least one hole in the carrier.

4: The decorative panel according to claim 3, wherein the internal face of the glass sheet matching with the at least one hole in the carrier is covered with a layer having a luminous transmittance of at least 1%.

5: The decorative panel for a vehicle's interior according to claim 1, wherein the internal face of the glass sheet is at least partially covered with a layer whose luminous transmittance is at least 1%.

6: The decorative panel according to claim 1, wherein the adhesion layer is adapted to be injected between the carrier and the internal face of the glass sheet.

7: The decorative panel according to claim 6, wherein the adhesion layer is further applied to at least one edge of the glass sheet.

8: The decorative panel according to claim 1, wherein the glass sheet is chemically tempered.

9: The decorative panel according to claim 1, wherein the internal face of the glass sheet further comprises a primer.

10: The decorative panel according to claim 1, wherein a primer is positioned between the carrier and the adhesion layer.

11: The decorative panel according to claim 1, wherein the external face of the glass sheet is decorated with a paint, through etching or with a layer deposited by plasma vapor deposition.

12: An illuminable decorative panel comprising:
a decorative panel according to claim 1; and
a light source,
wherein the decorative panel is fixed in the interior of a vehicle.

13: A method of manufacturing a decorative panel for a vehicle's interior comprising:
a. furnishing a glass sheet having an internal face and an external face;
b. furnishing a carrier adapted to fix the decorative panel on the vehicle; and
c. injecting an adhesion layer between the internal face of the glass sheet and the carrier, fully covering the internal face of the glass sheet, the luminous transmittance of the adhesion layer being at least 1%.

14: The method according to claim 13, further comprising, after furnishing the glass sheet, covering at least partially the internal face of the glass sheet with a layer whose luminous transmittance is below 1%.

15: The method according to claim 13, further comprising, after furnishing the glass sheet, covering at least partially the internal face of the glass sheet with a layer whose luminous transmittance is at least 1%.

16: The method according to claim 13, further comprising:
before furnishing the glass sheet, chemical tempering of the glass sheet; and
after furnishing the carrier, cold bending the chemically tempered glass sheet in the carrier.

17: The method according to claim 13, further comprising, before furnishing the carrier, covering the internal face of the glass sheet with a primer.

18: The method according to claim 13, wherein the adhesion layer is further applied to edges of the glass sheet.

19: The method according to claim 13, wherein the method is realized as a 2k-injection process, wherein the carrier is firstly injected and the adhesion layer is secondly injected.

20: The method according to claim 19, wherein the carrier is made of several sub-components.
